(19) United States
(12) Patent Application Publication
(10) Pub. No.: US 2015/0234491 A1
(43) Pub. Date: Aug. 20, 2015

(54) Data Transmission System, Data Transmission Method, Data Receiving Method, and Electronic Device

(71) Applicant: AU Optronics Corp., Hsin-Chu (TW)

(72) Inventors: Gui-Wen Liu, Hsin-Chu (TW); Chao-Chen Wang, Hsin-Chu (TW); Chao-Chuan Chen, Hsin-Chu (TW)

(73) Assignee: AU Optronics Corp., Hsin-Chu (TW)

(21) Appl. No.: 14/293,079

(22) Filed: Jun. 2, 2014

(30) Foreign Application Priority Data
Feb. 14, 2014 (TW) 103104966

(51) Int. Cl. G06F 3/044

(52) U.S. Cl. CPC G06F 3/044

(57) ABSTRACT

A data transmission system, a data transmission method, a data receiving method, and an electric device are disclosed. The data transmission method is adapted to transmit data of a first device to a second device. The first device includes a first capacitance touch panel, and the second device includes a second capacitance touch panel. The data transmission method includes the following steps. After the data is selected in the first device, the first capacitance touch panel is aligned with the second capacitance touch panel. The first device supplies the data to the first capacitance touch panel to form the capacitive coupling between the first capacitance touch panel and the second capacitance touch panel. The second device obtains the data through the capacitive coupling between the first capacitance touch panel and the second capacitance touch panel.

### CROSS-REFERENCE TO RELATED APPLICATIONS

This non-provisional application claims priority under 35 U.S.C. §119(a) on Patent Application No(s). 103104966 filed in Taiwan, R.O.C. on Feb. 14, 2014, the entire contents of which are hereby incorporated by reference.

### TECHNICAL FIELD

The disclosure relates to a data transmission system, a data transmission method, a data receiving method, and an electric device, more particularly to a data transmission system, a data transmission method, a data receiving method, and an electric device, which are capable of transmitting data through capacitive coupling.

### BACKGROUND

With the enhancement of capacitive touch control, more electric products, such as smart phones and tablet computers, are disposed with a capacitance touch panel for users to intuitively operate the electric products. If one aforementioned electric product intends to send data to another, the data can be sent with the wired communication or the wireless communication. However, to support the wireless communication nowadays, such as the Zigbee, the Bluetooth, WiFi, the near field communication (NFC), or the ultra-wideband (UWB), these electric products have to add a communication chip corresponding to the wireless communication, resulting in the increase of the manufacturing costs.

### SUMMARY

According to one or more embodiments, the disclosure provides a data transmission method for a first device which may be installed with a first application program and include a first capacitance touch panel including a first electrode part and a second electrode part. In one embodiment, the data transmission method may include the following steps. First, a data signal may be sent to the first capacitance touch panel, and the data signal may carry data sent by the first device and at least have a first voltage and a second voltage. Then, at least one of the first and second electrode parts of the first capacitance touch panel may selectively be enabled with the first voltage or the second voltage according to the data signal, so that capacitive coupling may occur between the at least enabled one of the first and second electrode parts and at least one third electrode part of the second capacitance touch panel. Therefore, the second capacitance touch panel may be able to receive the data from the first device.

According to one or more embodiments, the disclosure provides a data receiving method for a second device which may be installed with a second application program and include a second capacitance touch panel including a third electrode part and a fourth electrode part. In one embodiment, the data receiving method may include the following steps. First, at least one of a third and a fourth electrode part may sense a data signal inputted in a first capacitance touch panel, and the data signal may at least have a first voltage or a second voltage. Next, according to change of capacitive coupling between the second capacitance touch panel and the first capacitance touch panel, at least one of the third and fourth electrode parts may generate a first waveform corresponding to the first voltage and a second waveform corresponding to the second voltage. Accordingly, data carried by the data signal may be obtained according to the first waveform and the second waveform.

According to one or more embodiments, the disclosure provides a data transmission system for transmitting a data signal which may at least have a first voltage and a second voltage. In one embodiment, the data transmission system may include a first device and a second device. The first device may include a first capacitance touch panel which may include a first electrode part and a second electrode part. The second device may include a second capacitance touch panel which may include a third electrode part and a fourth electrode part. When the first capacitance touch panel is aimed at or aligned with the second capacitance touch panel, the first device may send the data signal to the first capacitance touch panel, so that at least one of the first and second electrode parts in the first capacitance touch panel may be enabled with the first voltage or the second voltage. Then, capacitive coupling may occur between the at least enabled one of the first and second electrode parts and at least one of the third and fourth electrode parts of the second capacitance touch panel. Therefore, the second capacitance touch panel may obtain data that is sent by the first device and carried by the data signal.

According to one or more embodiments, the disclosure provides a data transmission method for transmitting data from a first device to a second device. The first device may include a first capacitance touch panel, and the second device may include a second capacitance touch panel. In one embodiment, the data transmission method may include the following steps. First, data to be sent by the first device may be selected. Then, the first capacitance touch panel may be aimed at the second capacitance touch panel. The data to be sent by the first device may be provided to the first capacitance touch panel, so that capacitive coupling may occur between the first capacitance touch panel and the second capacitance touch panel. Finally, according to change of the capacitive coupling between the first capacitance touch panel and the second capacitance touch panel, the second device may obtain the data from the first device.

According to one or more embodiments, the disclosure provides an electric device. In one embodiment, the electric device may include a casing, a capacitance touch panel, and a conductive part. The capacitance touch panel may be disposed at one surface of the casing, and the conductive part may be disposed at another surface of the casing. The capacitance touch panel may include a first electrode part and a second electrode part. Further, the first electrode part and the second electrode part may selectively be enabled with a data signal at a first voltage or a second voltage, or may sense change of capacitive coupling to obtain data carried by the data signal. The conductive part may be enabled with the data signal at the first voltage or the second voltage, or may sense the change of the capacitive coupling to obtain the data carried by the data signal.

### BRIEF DESCRIPTION OF THE DRAWINGS

The present disclosure will become more fully understood from the detailed description given herein below for illustration only and thus does not limit the present disclosure, wherein:

FIG. 1 is a block diagram of a data transmission system according to one embodiment;

FIG. 2 is a cross-sectional view of the data transmission system in FIG. 1;

FIG. 3 is a block diagram of an electric device according to one embodiment;

FIG. 4 is a cross-sectional view of the electric device in FIG. 3;

FIG. 5A is a cross-sectional view of a data transmission system according to one embodiment;

FIG. 5B is a cross-sectional view of a data transmission system according to one embodiment;

FIG. 6 is a flow chart of a data transmission method according to one embodiment;

FIG. 7 is a flow chart of a data transmission method according to one embodiment; and

FIG. 8 is a flow chart of a data receiving method according to one embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

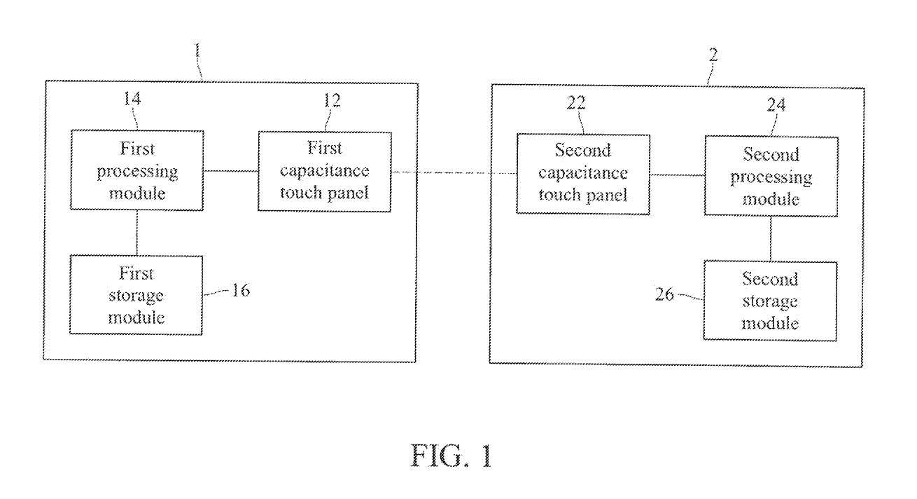

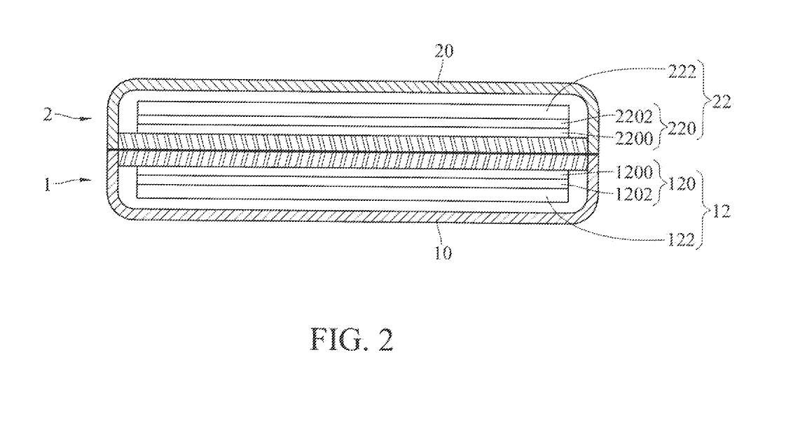

According to one or more embodiments, the disclosure provides a data transmission system as shown in FIG. 1 and FIG. 2. FIG. 1 is a block diagram of a data transmission system according to one embodiment, and FIG. 2 is a cross-sectional view of the data transmission system in FIG. 1. The data transmission system may mainly include a first device 1 and a second device 2. The first device 1 may have a casing 10 (as shown in FIG. 2) and include a first capacitance touch panel 12, a first processing module 14, and a first storage module 16. The second device 2 may have a casing 20 (as shown in FIG. 2) and include a second capacitance touch panel 22, a second processing module 24, and a second storage module 26. The first processing module 14 may couple with the first capacitance touch panel 12 and the first storage module 16, and the second processing module 24 may couple with the second capacitance touch panel 22 and the second storage module 26. In one exemplary embodiment, the first device 1 and the second device 2 may be smart phones or tablet computers, but the disclosure will not be limited thereto.

In the following description, every component in the first device 1 will be illustrated, and since the components in the second device 2 are the same as the relative components in the first device 1, they are not repeated hereinafter.

The casing 10 may have a top plane part, a side plane part, and a bottom plane part, and the top plane part and the bottom plane part of the casing 10 may be opposite to each other. The top plane part may have a good transmittance so that the top plane part may not affect the display of the first device 1. In one embodiment, the top plane part may be glass, acrylic, or other suitable light-transmissive material, but the disclosure will not be limited thereto. The top plane part may be a common material such as scratch-proof glass that is scratch-proof, shatterproof, and abrasion-resistant. The side plane part may be a frame whose material may be plastic, acrylic, metal, other suitable material, or a combination thereof, through which users can hold the first device 1 in their hand. The bottom plane part may contact the side plane part and face the top plane part. Therefore, the top plane part, the side plane part, and the bottom plane part may cooperate to form a space.

In one embodiment, the side plane part and the bottom plane part may be elements in an integrated structure where the top plane part may be formed in the side plane part with the glass injection molding (GIM), such that the internal surface of the side plane part may contact the top plane part. In one embodiment, the side plane part and the bottom plane part may be separable to each other. In this case, one or more batteries in the first device 1 may be able to be replaced, the bottom plane part may be determined as a back cover, a fastening structure may be disposed at the interface between bottom the plane part and the side plane part to steady assemble the bottom plane part and the side plane part together, but he disclosure will not be limited thereto. The disclosure does not have any limitations on the shape of the casing 10 (for example, the corners of the casing 10 are arc angles or right angles), the aspect ratio of the top plane part, and the aspect ratio of the side plane part. In one embodiment, there is a sensing module disposed at the side plane part such that some function keys may be able to be disposed on the top surface of the side plane part. Alternately, these function keys may be disposed on an external surface of the side plane part. For example, the volume control key may be disposed on the external surface of the side plane part.

The first capacitance touch panel 12 may be disposed in the space and include a touch module 120 and a display module 122. The touch module 120 may be located between the display module 122 and the top plane part of the casing 10. The touch module 120 may support an input function associated with the display module 122. Specifically, the touch module 120 may include a first electrode part 1200 and a second electrode part 1202. The first electrode part 1200 may include a plurality of first sensor serials arranged along a first direction, and the second electrode part 1202 may include a plurality of second sensor serials arranged along a second direction. There may be no limitations on the material of the first electrode part 1200 and the second electrode part 1202 in the disclosure. In one embodiment, the first electrode part 1200 and the second electrode part 1202 may be transparent conductive films, the material of the transparent conductive film may be indium tin oxide (ITO), indium zinc oxide (IZO), or similar transparent conductive oxide (TCO), and the transparent conductive film may have a transparency more than 80%. In one embodiment, the first electrode part 1200 and the second electrode part 1202 may be two different or independent conductive layers between which there may be a insulation layer whose material may have a high transmittance, such as silicon dioxide, silicon nitride, or a combination thereof, but the disclosure will not be limited thereto. In one alternate embodiment, the first electrode part 1200 and the second electrode part 1202 may be combined to produce a single conductive layer, but the disclosure will not be limited thereto.

The display module 122 may be located between the touch module 120 and the bottom plane part of the casing 10 and show an operation interface for the first device 1. In one exemplary embodiment, the display module 122 may be a light emitting diode (LED) display panel, a liquid crystal display (LCD), or other type display panel, but the disclosure will not be limited thereto.

The first processing module 14 may determine the operational states of the first device 1 and operate in response to according to user's function commands. In one or more embodiments, the first processing module 14 may control the voltage applied to the first electrode part 1200 or the second electrode part 1202, and process the data sensed by the first electrode part 1200 or the second electrode part 1202. In one exemplary embodiment, the first processing module 14 may be a central processing unit (CPU) or a micro control unit (MCU), but the disclosure will not be limited thereto.

The first storage module 16 may store data of the first device 1, the data may be one or more text files, image files, audio files, video files, execution files, compression files, or any combination thereof. In one or more exemplary embodiments, the first storage module 16 may be a programmable read-only memory (PROM), an erasable programmable read-only memory (EPROM), an electrically erasable programmable read-only memory (EEPROM), a flash memory, other type non-volatile memory, a dynamic random access memory (DRAM), a static random access memory (SRAM), other type volatile memory, or any possible combination thereof, but the disclosure will not be limited thereto.

In particular operation, the data transmission system may send a data signal carrying data stored in the first storage module 16 of the first device 1 to the second device 2. That is, the data signal may specify data to be sent by the first device 1, and at least have a first voltage (e.g. a high voltage) and a second voltage (e.g. a low voltage). In one or more exemplary embodiments, when the first capacitance touch panel 12 of the first device 1 is aimed at the second capacitance touch panel 22 of the second device 2 (as shown in FIG. 2), the first device 1 may send the data signal to the first capacitance touch panel 12 via the first storage module 16, and then the first electrode part 1200, the second electrode part 1202, or both in the first capacitance touch panel 12 may selectively enabled with the first voltage or the second voltage. Therefore, the enabled first electrode part 1200, the second electrode part 1202, or both may cooperate with the third electrode part 2200, the fourth electrode part 2202, or both in the second capacitance touch panel 22 of the second device 2 to form capacitive coupling, and then the second capacitance touch panel 22 of the second device 2 may acquire the data carried by the data signal and store the acquired data in the second storage module 26.

In details, when the capacitive coupling occurs between the enabled first electrode part 1200, second electrode part 1202, or both in the first capacitance touch panel 12 and the third electrode part 2200, fourth electrode part 2202, or both in the second capacitance touch panel 22, the distance between an external surface of the first capacitance touch panel 12 and an external surface of the second capacitance touch panel 22 may be smaller than a default value. In other words, when the distance between the top plane part of the casing 10 of the first device 1 and the top plane part of the casing 20 of the second device 2 is smaller than the default value and the first capacitance touch panel 12 is enabled, the capacitive coupling may occur between the first capacitance touch panel 12 and the second capacitance touch panel 22. However, the disclosure will not be limited by the default value, and the default value can suitably be designed according to actual application requirements by a person with ordinary skills in the art.

Moreover, the first electrode part 1200, the second electrode part 1202, or both in the first capacitance touch panel 12 of the first device 1 may be enabled with one or more voltages carrying different pieces of data, and thus, the second capacitance touch panel 22 of the second device 2 may acquire multiple pieces of data. Specifically, when the first capacitance touch panel 12 of the first device 1 is aimed at the second capacitance touch panel 22 of the second device 2 to transmit multiple pieces of data, some first sensor serials of the first electrode part 1200 or some second sensor serials of the second electrode part 1202 in the first capacitance touch panel 12 may be enabled with the voltage carrying first data, and the other first sensor serials of the first electrode part 1200 or the other second sensor serials of the second electrode part 1202 may be enabled with the voltage carrying second data. Accordingly, some third sensor serials of the third electrode part 2200 or some fourth sensor serials of the fourth electrode part 2202 in the second capacitance touch panel 22 may cooperate with the region of the first capacitance touch panel 12 for transmitting the first data, to form the capacitive coupling, and the other third sensor serials of the third electrode part 2200 or the other fourth sensor serials of the fourth electrode part 2202 in the second capacitance touch panel 22 may cooperate with the region of the first capacitance touch panel 12 for transmitting the second data, to form the capacitive coupling. In this way, the second capacitance touch panel 22 of the second device 2 may simultaneously acquire the first data and the second data.

The disclosure does not have any limitation on the number of pieces of data simultaneously transmitted between the first device 1 and the second device 2, that is, there are a plurality of transmission channels for transmitting many pieces of data between the first device 1 and the second device 2. In addition, to prevent these pieces of data from being affected by each other during the simultaneous transmission, a boundary area may be set between every two transmission channels. For this, partial electrode part between the electrode part for transmitting the first data and the electrode part for transmitting the second data may not be enabled.

The above embodiments of the data transmission system, the transmission of the data signal may be based on the capacitive coupling between the first capacitance touch panel 12 and the second capacitance touch panel 22 in the two electric devices which face to each other. In the following one or more embodiments of the data transmission system,

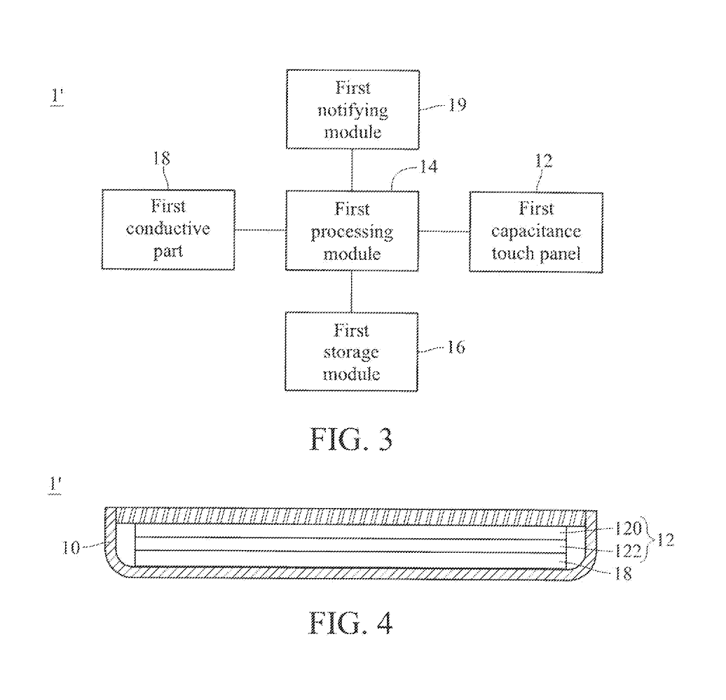

According to one or more other embodiments, the electric device in the disclosure may be shown in FIG. 3 and FIG. 4. FIG. 3 is a block diagram of an electric device according to one embodiment, and FIG. 4 is a cross-sectional view of the electric device in FIG. 3. A first device 1′ may includes a casing 10 (as shown in FIG. 4), a first capacitance touch panel 12, a first processing module 14, a first storage module 16, a first conductive part 18, and a first notifying module 19. The first processing module 14 may couple with the first capacitance touch panel 12, the first storage module 16, the first conductive part 18, and the first notifying module 19. Since most of function modules in the first device 1′ are the same as the relative function modules in the first device 1 in FIG. 1, they will not be repeated hereinafter.

Compared with the first device 1 in FIG. 1, the first device 1′ in FIG. 3 may further include a first conductive part 18 and a first notifying module 19. The first conductive part 18 may be disposed and located at a surface of the first device 1′ (i.e. the surface close to the bottom plane part of the casing 10) opposite to an external surface of the first capacitance touch panel 12. The first conductive part 18 may selectively be enabled with the first voltage or the second voltage. In one or more embodiments, the third electrode part 2200, the fourth electrode part 2202, or both in the second capacitance touch panel 22 may selectively cooperate with the enabled first electrode part 1200, second electrode part 1202, or both or with the enabled first conductive part 18 to form capacitive coupling.

The first notifying module 19 may generate a notice signal according to the transmission states of the data signal and receive an operation command inputted by a user, and then the first device 1′ may operate according to the operation command. In one embodiment, the first notifying module 19 may be a touch display panel, the touch display panel may be exposed or visible at the surface of the first device 1′ (i.e. the bottom plane part of the casing 10) opposite to the external surface of the first capacitance touch panel 12, the notice signal may be shown as images or light, and the operation command may be generated by touching the touch display panel. Users may be allowed to control the first device 1′ via the first capacitance touch panel or the touch display panel. In one alternate embodiment, the first notifying module 19 may include an audio output unit (e.g. a speaker or an earphone jack) and an audio input unit (e.g. a microphone), and the notice signal may be outputted as sounds by the audio output unit, the operation command may be generated by the audio input unit receiving users' voices. Therefore, users may be allowed to use their voices to control the first device 1′.

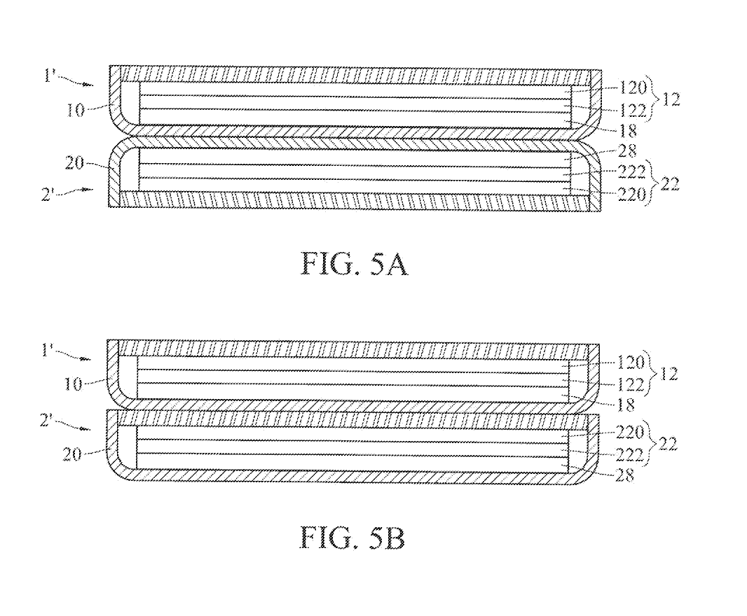

On the other hand, the second device 2′ may further include a second conductive part 28 (as shown in FIG. 5A and FIG. 5B) and a second notifying module, and since the second notifying module in the second device 2′ is the same as the first notifying module 19 in the first device 1′, it will not be repeated hereinafter. The other function modules in the second device 2′ are the same as the relative function modules in the second device 2 in FIG. 1, and thus, they are not figured. The second conductive part 28 may be disposed and located at a surface of the second device 2′ (i.e. the bottom plane part of the casing 20) opposite to an external surface of the second capacitance touch panel 22. The second conductive part 28 may selectively sense the data signal inputted in the first capacitance touch panel 12, so that the first capacitance touch panel 12 of the first device 1′ may selectively cooperate with the second conductive part 28 or with the third electrode part 2200, the fourth electrode part 2202, or both in the second capacitance touch panel 22 in the second device 2′ to form capacitive coupling.

FIG. 5A is a cross-sectional view of a data transmission system according to one embodiment. When a user intends to transmit data in the first device 1′ to the second device 2′ and the first conductive part 18 of the first device 1′ is aimed at the second conductive part 28 of the second device 2′, the first conductive part 18 may be enabled with a first voltage or a second voltage. Also, the second conductive part 28 of the second device 2′ may sense a data signal inputted in the first conductive part 18 and according to the change of the capacitive coupling between the first conductive part 18 and the second conductive part 28, generate a first waveform and a second waveform. The first waveform may correspond to the first voltage, and the second waveform may correspond to the second voltage. Accordingly, the second processing module 24 in the second device 2′ may acquire data carried by the data signal according to the first waveform and the second waveform, and store the acquired data in the second storage module 26. The disclosure may have no limitations on the first voltage, the second voltage, the first waveform, and the second waveform. In other words, these voltages and these waveforms can be designed according to actual application requirements by a person with ordinary skills in the art. In one or more embodiments, the first waveform and the second waveform may be a cosine or sine wave and respectively have different frequencies and phases, may be square waves and respectively have different amplitudes, or may be composite waves.

FIG. 5B is a cross-sectional view of a data transmission system according to one embodiment. When a user intends to transmit data in the first device 1′ to the second device 2′ and the first conductive part 18 of the first device 1′ is aimed at the second capacitance touch panel 22 of the second device 2′, the first conductive part 18 may be enabled with a first voltage or a second voltage, and then the third electrode part 2200, the fourth electrode part 2202, or both in the second capacitance touch panel 22 in the second device 2′ may sense the data signal inputted in the first conductive part 18. Also, according to the change of the capacitive coupling between the second capacitance touch panel 22 and the first conductive part 18, the third electrode part 2200, the fourth electrode part 2202, or both in the second capacitance touch panel 22 may generate a first waveform and a second waveform. The first waveform may correspond to the first voltage, and the second waveform may correspond to the second voltage. Accordingly, the second processing module 24 in the second device 2′ may acquire the data carried by the data signal according to the first waveform and the second waveform and store the acquired data in the second storage module 26.

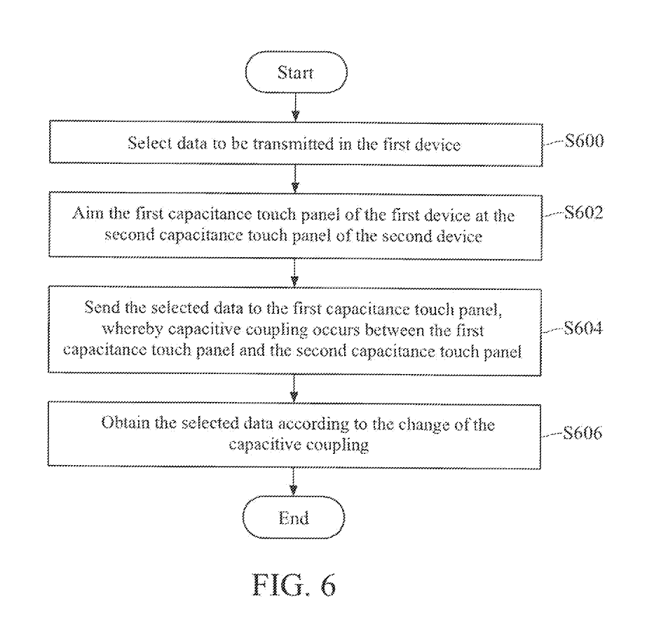

FIG. 6 is a flow chart of a data transmission method according to one embodiment. The data transmission method may be applied to send data in the first device 1 to the second device 2 in FIG. 1 and FIG. 2. The first device 1 may include the first capacitance touch panel 12, and the second device 2 may the second capacitance touch panel 22.

First, as shown in step S600, a user may use an application program to select data to be transmitted in the first device 1, and as shown in step S602, the user manually aims the first capacitance touch panel 12 of the first device 1 at the second capacitance touch panel 22 of the second device 2. Then, as shown in step S604, when the first device 1, the second device 2, or both ensure that the first capacitance touch panel 12 has been aimed at the second capacitance touch panel 22, the first device 1 may send the selected data to the first capacitance touch panel 12, whereby capacitive coupling may occur between the first capacitance touch panel 12 and the second capacitance touch panel 22. Finally, as shown in step S606, the second device 2 may obtain the selected data in the first device according to the change of the capacitive coupling between the second capacitance touch panel 22 and the first capacitance touch panel 12.

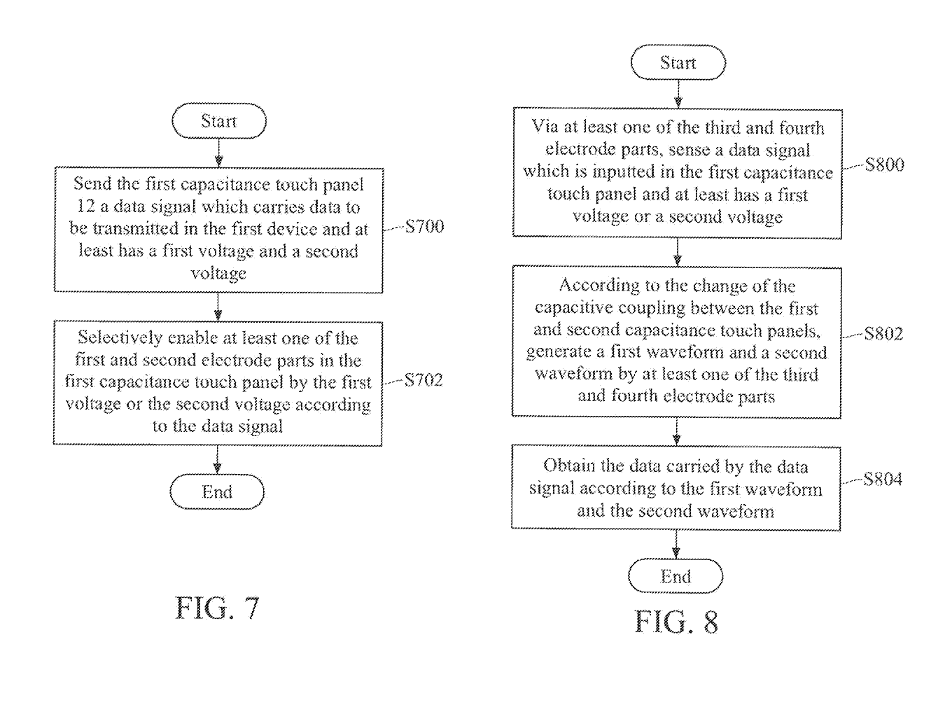

FIG. 7 is a flow chart of a data transmission method according to one embodiment. The data transmission method may be applied to the first device 1 installed with a first application program in FIG. 1 and FIG. 2. In the first device 1, the first capacitance touch panel 12 may include the first electrode part 1200 and the second electrode part 1202. The first electrode part 1200 may include a plurality of first sensor serials arranged along a first direction, and the second electrode part 1202 may include a plurality of second sensor serials arranged along a second direction.

First, as shown in step S700, the first storage module 16 in the first device 1 may send a data signal to the first capacitance touch panel 12, and the data signal may carry data to be transmitted in the first device 1 and at least have a first voltage and a second voltage. Then, as shown in step S702, the first processing module 14 in the first device 1 may selectively enable the first electrode part 1200, second electrode part 1202, or both in the first capacitance touch panel 12 by the first voltage or the second voltage according to the data signal. Therefore, capacitive coupling may occur between the enabled first electrode part 1200, second electrode part 1202, or both and at least one electrode part of the second capacitance touch panel 22 of the second device 2, and then the second capacitance touch panel 22 may receive the data to be transmitted in the first device 1.

Besides, before the data signal is sent to the first capacitance touch panel 12 (step S700), the first device 1 may execute the first application program to ensure that the first capacitance touch panel 12 in the first device 1 is aimed at the second capacitance touch panel 22 in the second device 2.

FIG. 8 is a flow chart of a data receiving method according to one embodiment. The data receiving method may be applied to the second device 2 installed with a second application program in FIG. 1 and FIG. 2. In the second device 2, the second capacitance touch panel 22 may include the third electrode part 2200 and the fourth electrode part 2202. The third electrode part 2200 may include a plurality of third sensor serials arranged along a first direction, and the fourth electrode part 2202 may include a plurality of fourth sensor serials arranged along a second direction.

First, as shown in step S800, the third electrode part 2200, the fourth electrode part 2202, or both in the second device 2 may sense a data signal inputted in the first capacitance touch panel 12 in the first device 1, and the data signal may at least have a first voltage or a second voltage. Then, as shown in step S802, the third electrode part 2200, the fourth electrode part 2202, or both in the second device 2 may generate a first waveform and a second waveform according to the change of the capacitive coupling between the second capacitance touch panel 22 and the first capacitance touch panel 12. The first waveform may correspond to the first voltage, and the second waveform may correspond to the second voltage. Finally, as shown in step S804, the second processing module 24 in the second device 2 may obtain the data carried by the data signal according to the first waveform and the second waveform, and store the obtained data in the second storage module 26.

In addition, before the third electrode part 2200, fourth electrode part 2202, or both sense the data signal inputted by the first capacitance touch panel 12 (step S800), the second device 2 may execute the second application program to ensure that the second capacitance touch panel 22 in the second device 2 is aimed at the first capacitance touch panel 12 in the first device 1.

In conclusion, the disclosure provides a data transmission system, a data transmission method, a data receiving method, and an electric device and transmit a data signal with the change of capacitive coupling between the capacitance touch panels of two electric devices, whereby the disclosure may unnecessarily add or modify touch control chips to drive the capacitance touch panels and add sensors, so as to save the space in the electric device. Moreover, the two electric devices may further include a conductive part opposite to the capacitance touch panel, and the two electric devices may selectively transmit or receive the data signal through the capacitance touch panels or the conductive parts. When the data signal is transmitted between the two electric devices, the two electric devices may simultaneously perform other functions or know the transmission states of the data signal, resulting in the convenience in use. Therefore, the disclosure may have higher practicability but lower manufacturing costs.

What is claimed is:

1. A data transmission method for a first device which is installed with a first application program and comprises a first capacitance touch panel comprising a first electrode part and a second electrode part, comprising:
sending the first capacitance touch panel a data signal which specifies data to be transmitted in the first device and at least works at a first voltage and a second voltage; and
enabling at least one of the first and second electrode parts in the first capacitance touch panel according to the first voltage or the second voltage of the data signal;
wherein after capacitive coupling is formed between the at least enabled one of the first and second electrode parts and at least one third electrode part in a second capacitance touch panel, the second capacitance touch panel receives the data to be transmitted in the first device.

2. The data transmission method according to claim 1, wherein when the capacitive coupling is formed between the at least enabled one of the first and second electrode parts and the at least one third electrode part in a second capacitance touch panel, a distance between an external surface of the first capacitance touch panel and an external surface of the second capacitance touch panel have is smaller than a default value.

3. The data transmission method according to claim 1, wherein before the data signal is sent to the first capacitance touch panel, the first device executes the first application program to aim the first capacitance touch panel at the second capacitance touch panel.

4. The data transmission method according to claim 1, wherein the first device further comprises a first conductive part which is disposed at a surface of the first device opposite to an external surface of the first capacitance touch panel, and the first conductive part is selectively enabled with the first voltage or the second voltage, whereby the at least one third electrode part of the second capacitance touch panel selectively operates with the at least enabled one of the first and second electrode parts or with the enabled first conductive part to form capacitive coupling.

5. The data transmission method according to claim 1, wherein the first device further comprises a first notifying module which is configured to generate a notice signal according to transmission state of the data signal and receive an operation command according to which the first device operates.

6. The data transmission method according to claim 5, wherein the first notifying module is a touch display panel which is exposed at a surface of the first device opposite to an external surface of the first capacitance touch panel, and the notice signal is shown as images or light, and the operation command is generated by touching the touch display panel.

7. The data transmission method according to claim 5, wherein the first notifying module comprises an audio output unit and an audio input unit, the notice signal is outputted as sounds by the audio output unit, and the operation command is generated by the audio input unit receiving a user's voice.

8. A data receiving method for a second device which is installed with a second application program and comprises a second capacitance touch panel which comprises a third electrode part and a fourth electrode part, comprising:
via at least one of the third and fourth electrode parts, sensing a data signal which is inputted into a first capacitance touch panel and at least has a first voltage or a second voltage;
via at least one of the third and fourth electrode parts, generating a first waveform, which corresponds to the first voltage, and a second waveform, which corresponds to the second voltage, according to change of capacitive coupling between the second capacitance touch panel and the first capacitance touch panel; and
acquiring data carried by the data signal according to the first waveform and the second waveform.

9. The data receiving method according to claim 8, wherein when the capacitive coupling is formed between the second capacitance touch panel and the first capacitance touch panel, a distance between an external surface of the first capacitance touch panel and an external surface of the second capacitance touch panel is smaller than a default value.

10. The data receiving method according to claim 8, wherein before at least one of the third and fourth electrode parts senses the data signal inputted into the first capacitance touch panel, the second device executes the second application program to aim the second capacitance touch panel at the first capacitance touch panel.

11. The data receiving method according to claim 8, wherein the second device further comprises a second conductive part, the second conductive part is disposed at a surface of the second device which is opposite to an external surface of the second capacitance touch panel, the second conductive part is configured to selectively sense the data signal inputted into the first capacitance touch panel such that the first capacitance touch panel selectively cooperates with at least one of the second or third and fourth electrode parts to form the capacitive coupling.

12. The data receiving method according to claim 8, wherein the second device further comprises a second notifying module, the second notifying module is configured to generate a notice signal according to receiving states of the data signal and to receive an operation command according to which the second device operates.

13. The data receiving method according to claim 12, wherein the second notifying module is a touch display panel, the touch display panel is exposed at a surface of the second device which is opposite to an external surface of the second capacitance touch panel, the notice signal is shown as images or light, and the operation command is generated by touching the touch display panel.

14. The data receiving method according to claim 12, wherein the second notifying module comprises an audio output unit and an audio input unit, the notice signal is outputted as sounds by the audio output unit, and the operation command is generated by the audio input unit receiving a user's voice.

15. A data transmission system for transmitting a data signal at least working at a first voltage and a second voltage, comprising:
a first device, comprising a first capacitance touch panel comprising a first electrode part and a second electrode part; and
a second device, comprising a second capacitance touch panel comprising a third electrode part and a fourth electrode part;
wherein when the first capacitance touch panel is aimed at the second capacitance touch panel, at least one of the first and second electrode parts in the first capacitance touch panel is selectively enabled with the data signal at the first voltage or the second voltage sent by the first device, to form capacitive coupling between the at least enabled one of the first and second electrode parts and at least one of the third and fourth electrode parts, and then the second capacitance touch panel acquires data carried by the data signal specifying data to be transmitted in the first device.

16. The data transmission system according to claim 15, wherein when the capacitive coupling is formed between the at least enabled one of the first and second electrode parts in the and at least one of the third and fourth electrode parts, a distance between an external surface of the first capacitance touch panel and an external surface of the second capacitance touch panel is smaller than a default value.

17. The data transmission system according to claim 15, wherein the first device further comprises a first conductive part, the first conductive part is located at a surface of the first device opposite to an external surface of the first capacitance touch panel, the first conductive part is selectively enabled with the first voltage or the second voltage, and at least one of the third and the fourth electrode parts of the second capacitance touch panel selectively cooperates with the at least enabled one of the first and the second electrode parts or the enabled first conductive part to form the capacitive coupling.

18. The data transmission system according to claim 15, wherein the second device further comprises a second conductive part, the second conductive part is disposed at a surface of the second device opposite to an external surface of the second capacitance touch panel, the second conductive part is configured to selectively sense the data signal inputted into the first capacitance touch panel such that the first device selectively cooperates with at least one of the second or the third and the fourth electrode parts to form the capacitive coupling.

19. A data transmission method for transmitting data in a first device to a second device, wherein the first device comprises a first capacitance touch panel, the second device comprises a second capacitance touch panel, and the data transmission method comprises:
selecting data to be transmitted in the first device;
aiming the first capacitance touch panel at the second capacitance touch panel;
sending data to be transmitted in the first device to the first capacitance touch panel, whereby capacitive coupling is formed between the first capacitance touch panel and the second capacitance touch panel; and
acquiring the data from the first device according to change of the capacitive coupling between the second capacitance touch panel and the first capacitance touch panel by the second device.

20. The data transmission method according to claim 19, wherein when the capacitive coupling is formed between the first capacitance touch panel and the second capacitance touch panel, a distance between an external surface of the first capacitance touch panel and an external surface of the second capacitance touch panel is smaller than a default value.

21. The data transmission method according to claim 19, wherein the first device further comprises a first conductive part, the first conductive part is disposed at a surface of the first device which is opposite to an external surface of the first capacitance touch panel, and the first capacitance touch panel or the first conductive part cooperates with the second capacitance touch panel to form the capacitive coupling in the first device.

22. The data transmission method according to claim 19, wherein the second device further comprises a second conductive part, the second conductive part is disposed a surface of the second device which is opposite to an external surface of the second capacitance touch panel, and the second capacitance touch panel or the second conductive part cooperates with the first capacitance touch panel to form the capacitive coupling in the second device.

23. An electric device, comprising:
a casing;
a capacitance touch panel, disposed at one surface of the casing, comprising a first electrode part and a second electrode part, wherein the first electrode part and the second electrode part are configured to selectively be enabled with a data signal at a first voltage or a second voltage or sense change of capacitive coupling to acquire data carried by the data signal; and
a conductive part, disposed at another surface of the casing, and configured to selectively be enabled with the data signal at the first voltage or the second voltage or sense the change of capacitive coupling to acquire the data carried by the data signal.

24. The electric device according to claim 23, wherein the electric device further comprises a notifying module, the notifying module is configured to generate a notice signal according to transmission states that the capacitance touch panel or the conductive part transmits the data signal, and to receive an operation command according to which the electric device operates.

25. The electric device according to claim 24, wherein the notifying module is a touch display panel, the touch display panel is exposed at another surface of the casing, the notice signal is shown with images or light, and the operation command is generated by touching the touch display panel.

26. The electric device according to claim 24, wherein the notifying module comprises an audio output unit and an audio input unit, the notice signal is outputted sounds by the audio output unit, and the operation command is generated by the audio input unit receiving a user's voice.
